(19) United States
(12) Patent Application Publication
(10) Pub. No.: US 2009/0150564 A1
(43) Pub. Date: Jun. 11, 2009

(54) PER-USER BANDWIDTH AVAILABILITY

(76) Inventors: Dorai Ashok Anbalagan, Nolambur (IN); Matthew Nicolas Petach, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/953,582

(22) Filed: Dec. 10, 2007

(51) Int. Cl. G06F 15/173

(52) U.S. Cl. 709/241

(57) ABSTRACT

A system for calculating bandwidth availability for best servicing a user is disclosed. The system optimizes network performance and network utilization by making use of routing table information and bandwidth utilization information between the servers and the user.

### FIELD OF THE INVENTION

The present invention relates to servicing a data requests from users. More particularly, the invention relates to servicing the data requests based on bandwidth availability.

### BACKGROUND

Requesting data from the Internet can result in slow response times to a user. One reason for this is that a content provider servicing the request may have multiple datacenters geographically dispersed worldwide, and the user may connect to a datacenter that is less efficient at servicing requests from that user. Each datacenter can have, for example, multiple computer network devices. The content provider must manage the user traffic (bandwidth utilization) across numerous links which connect all of the datacenters.

The content provider sometimes has the option of serving a user via numerous datacenters. However, there are instances in which the wrong datacenter can be chosen, so that the data is not served, or is served very slowly, to the user.

Slow service occurs at least partly because of the content provider having difficulty in determining the bandwidth utilization of the various computer network devices within the content provider's control. Additionally, some of the links used by the content provider may be owned or managed by competitors, partners, and peers of the content provider. However, these competitors, partners, and peers may not be forthcoming with details about the internal mechanisms of their links.

Nonetheless, to the extent available, such information can be extremely helpful in serving a request for data from a user. Consequently, an improved mechanism for measuring network utilization and bandwidth availability, and also routing requests for data is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example system for managing requests for data, according to an embodiment of the invention;

FIG. 2 is a sequence diagram illustrating various events that may execute within a the system of FIG. 1; and

FIG. 3 shows a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

To achieve load-balancing of data traffic within a computer network, a system is provided, according to an embodiment of the invention, which regularly collects bandwidth utilization information of various links within that network at regular intervals, along with the configuration of each of these links. Upon receiving a request for data from a user, the system associates routing information with a user's Internet protocol (IP) address and calculates the bandwidth available to serve that user from a variety of data centers. The system processes this collected information and then provides that collected information to a routing module which then makes load-balancing decisions regarding the request for data from the user. These decisions include but are not limited to decisions that result in redirecting the user to a server in a different data center, where a larger amount of bandwidth may be available.

The system calculates the bandwidth availability of the various network links which can reach that particular user. Doing so enables a provider to balance traffic (requests for data from users) by serving the requested content from that co-located server which has the most bandwidth available relative to that user. That co-located server may not have the most bandwidth relative to other users. Performing such a calculation includes regularly measuring the status of the links to the various Internet Service Providers (ISPs), and potentially other partners of the content provider. A datacenter is where servers are hosted by the content provider to serve the Internet users.

If a content provider has multiple datacenters, it might be preferred to use all datacenters to serve the users instead of using a single datacenter, and also to balance usage of all datacenters while serving requests from users. To achieve this, it can be very useful to have a consolidated list of bandwidth availabilities for a specific user, which shows the bandwidth available for the user in various datacenters. Such a list is obtained by combining the bandwidth available on each of numerous network links within each of numerous datacenters that can be used to reach the user.

### Explanation of System

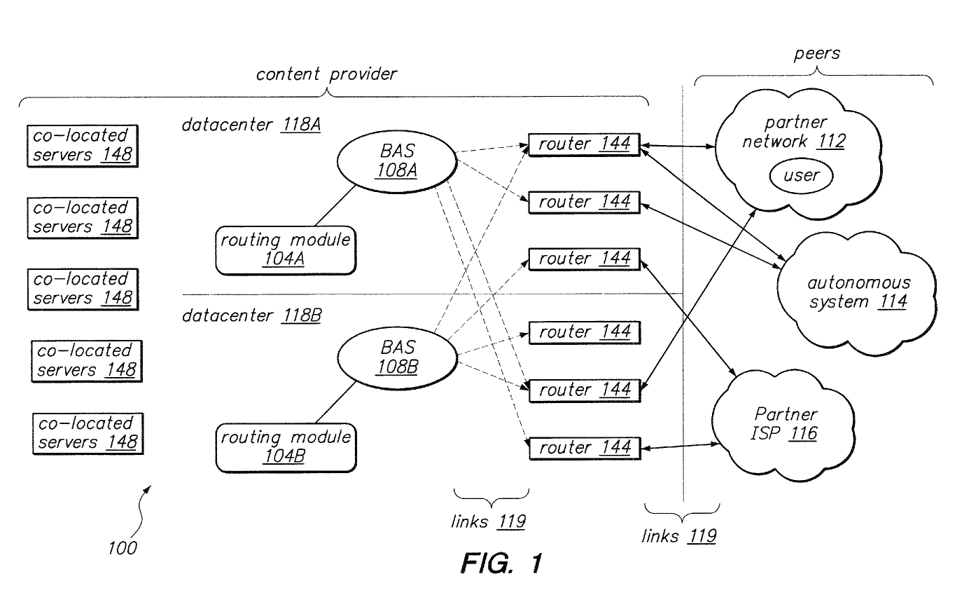

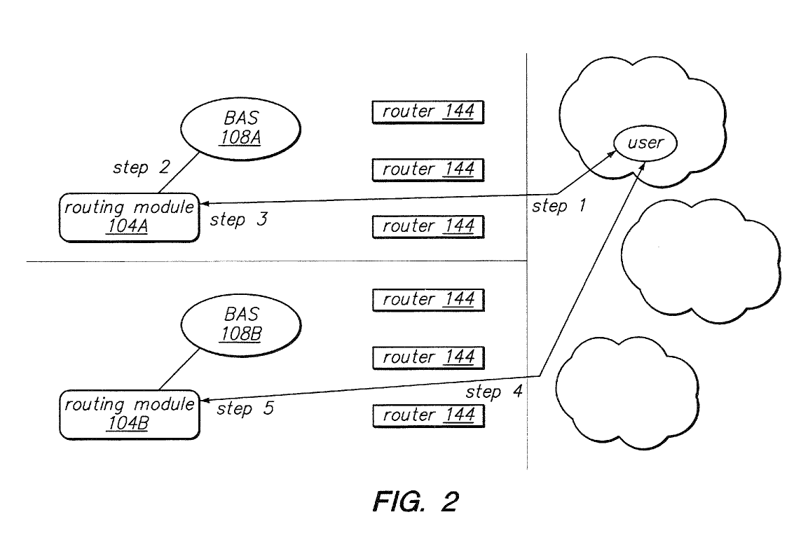

FIG. 1 shows a system 100 used by a content provider. Within the system 100, various links 119 are shown, represented by arrows. The links 119 can connect datacenters 118, routers 144, and various peers including but not limited to partner networks 112, autonomous systems 114, and partner ISPs 116. The system 100 connects a user to one of numerous co-located servers 148. Although FIGS. 1 and 2 show the user as being located within the partner network 112, the user could be located in any of the peers.

Within FIGS. 1 and 2 only two datacenters 118A and 118B are shown, although many more could be utilized within the system 100. Each datacenter comprises at least a routing module 104 and a bandwidth available service (BAS) 108. Within FIGS. 1 and 2, the datacenters 118A and 118B have been simplified for the purposes of brevity. A datacenter 118 contains many components other than what is shown.

The routing module 104 can be a load-balancing system, but can also perform other functions. The co-located servers 148 store data sought by users, and may be associated with a specific datacenter 118, but may also be located outside any specific datacenter 118.

A link 119 may comprise various computer networking components, including wire, switches, hubs, and other devices too numerous to mention. All links 119 comprise at least one and potentially more than one hop. For simplicity, only routers 144 are shown as part of the links 119 in FIGS. 1 and 2. Autonomous system numbers (ASNs) can be used to identify the various components within a link 119. The ASNs can be useful in determining and measuring the usage load present and bandwidth availability of the links 119. If the routers 144 use a border gateway protocol (BGP), then BGP can also be used to identify the various components within a link 119.

Regardless of the specific identifying mechanism, the various bandwidth availability services 108 collect bandwidth utilization information of the links 119 at regular intervals, along with the configurations and connections of each of these links 119. The configuration of a link 119 comprises information such as a peer ASN, the number of hops within that link, as well as the maximum rated speed of various components within the link 119 (to the extent available).

When a request for data arrives from a user, this collected utilization and available bandwidth information is then processed and served to the routing module 104 for load-balancing decisions as to which of the numerous links 119 to use for servicing the request for data from the user. This decision as to which link 119 to use includes but is not limited to decisions about redirecting a user to a co-located server 148 in a different data center 118 because a larger amount of bandwidth is available. The system 100 thus provides a consolidated list of bandwidth availability across numerous links 119 and datacenters 118 available for use by a particular user, rather than one single bandwidth figure for an entire datacenter.

The consolidate list is used to associate a specific link 119 with a requesting user's IP address, and to calculate the bandwidth available to serve that user from the various co-located servers 148. Working with the BAS 108, the routing module 104 locates and then prioritizes the various links 119 among the various co-located servers 148 thereby potentially providing a lower-cost link to the user.

FIG. 2 shows one potential sequence of steps used to operate the system 100. Within FIG. 2, the dotted line between the BAS 108 and the routers 144 indicate that the information extracted from the routers 144 could be indirect (multiple hops) or direct (single hop), depending on how the system 100 is structured.

As shown in FIG. 2, the system 100 works as follows.
1) a user requests the routing module 104A in the datacenter 118A to obtain media/data/content;
2) the routing module 104A requests the BAS 108A in the datacenter 118A for information on the bandwidth availability relative to that user, even though that datacenter 118A may not have the most bandwidth relative to other users;
3) the routing module 104A decides to redirect the user to the datacenter 118B due to greater unused bandwidth for that particular user at the datacenter B when compared to the datacenter A, based on the data provided by the BAS 108A. The routing module 104A then sends a “redirect” to the user;
4) the user then sends a request to the routing module 104B within datacenter 118B with a reference from datacenter 118A;
5) the routing module 104B serves the user's request from datacenter 118B.

It is necessary to re-route the original request because it is not possible to perform a “redirect” from the content provider (server) side. A typical web browser operated by a user does not have sufficient resources for a server to connect and automatically perform the redirect. Thus, the redirect must be performed user-side, rather than server-side.

The value of the reference from datacenter 118A is that another datacenter 118 can see that the user has already been refused connection and forced to redirect, and thus might be put at a higher priority. A request for data that comes accompanied with a reference from another dataserver might be granted a higher service priority than another request not accompanied by a reference.

### Content/Format of Reference

The reference contains query parameters, including but not limited to the URL sought by a user. Originally, a user might trigger a request to obtain data (whether video, large files, or something else) using the datacenter 118A. Supposing the user was seeking a Paris Hilton video from URL1, the request format might be formatted as follows:

URL1, Paris Hilton, Redirect=0

The user will not know which datacenter 118 is servicing the request. Within datacenter 118A, the routing module 104A will check with the BAS 108A. If the BAS 108A returns results which are below a predetermined threshold that is adjustable, such as but not limited to bandwidth is not available, the datacenter 118A will return a communication to the user's browser in the form of a reference, which may be formatted as follows:

URL2, Paris Hilton, Redirect=1

The user's browser will then re-send the request, using URL2, to a different datacenter 118 that is known to also have the ability to service the request. During the time of redirection, the user will not be aware that the request was redirected. Hopefully, the user will not notice the time lag caused by the redirection.

Within the system 100, all references contain parameters. The above reference has 3 parameters: URL2; Paris Hilton; and Redirect=1.

### Communication Between Routing Module and Bas

The routing module 104 communicates with the BAS 108 as follows. As stated, the routing module 104 receives a request for data from a user in the form of a URL, and potentially some other parameters. The routing module 104 then communicates that user's IP address to the BAS 108, as well as the URL containing the desired data. At this point, the BAS 108 knows every hop in the various links 119 that form the connection between the user and the final destination URL.

In response, the BAS 108 returns the bandwidth availability of numerous other datacenters 118, so as to provide the routing module 104 with a choice of datacenters to service the request. If the response from BAS 108 leaves the routing module 104 in a dilemma as to which datacenter 118 to use, it is up to the routing module 104 to include other factors to break the tie. The factors that the routing module 104 uses could be random.

Additionally, the routing module 104 can also inquire of the health of a specific datacenter 118, making inquiries about other factors besides mere bandwidth. Some of these factors can include server outages, denial-of-service attacks, electrical failures, or other infrastructure problems that could affect bandwidth but have not yet affected the existing bandwidth measurements.

The BAS 108 can have an internal cache. In such an instance, the routing module 104 may also communicate information to the BAS 108 regarding cache on or cache off. There may be instances in which the routing module 104 wishes to disable the cache.

### Calculating Bandwidth

Calculating the available bandwidth of a device such as a co-located server can be useful in making routing decisions. Total available bandwidth==SUM (speed of network link (i)−bandwidth used in network link (i)), where i==total network links which can reach a particular subnet. The speed of the network link is usually associated to the maximum bandwidth that the link can hold.

For the BAS 108 to calculate the bandwidth available for a particular user, the following steps are performed.
1) the BAS 108 queries the routers 144 with the user IP address for the routing path information (links), so as to determine the AS (Autonomous System or Partner Network) to which the user's IP address belongs;
2) the routers 144 return the bandwidth available on the various links 119;
3) not all links 119 can be employed to reach the user. To figure out those links 119 that can best serve the user, the BAS 108 queries the routers 144 again (shown by same dotted lines in the in FIGS. 1 and 2) and obtains the “next hop” AS (Autonomous System or Partner Network) for all the network links; and
4) the BAS 108 returns the bandwidth information to the routing module 104. In doing so, the BAS 108 identifies the links with “next hop” AS equal to the user AS (obtained in Step 1) because those are the links 119 suitable for reaching the user. The BAS 108 then calculates the bandwidth available on each of those links 119 in order to determine the best link to reach that user.

Within the system 100, the routers 144 may use border gateway protocol (BGP). However, other non-BGP embodiments are also contemplated.

### Load Balancer

Within the system 100, the routing module 104 can act as a load balancer to assist in deciding which co-located servers will be used to service a user. A load balancer is a device which operates as a type of server, accepts requests for content from users, and routes those requests to a co-located server 148 best suited for servicing the request. The data centers 118 housing the co-located servers 148 may have varying levels of available bandwidth. A co-located server with higher available bandwidth can result in lower cost to the content provider.

### Hardware Overview

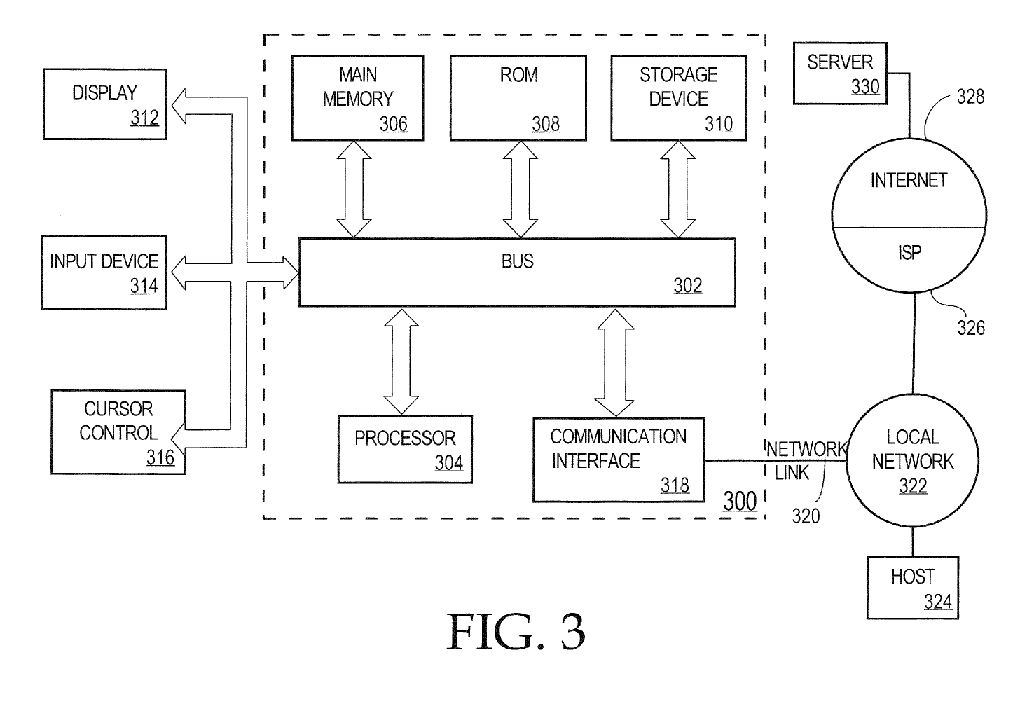

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another computer-readable storage medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable storage medium” as used herein refers to any medium that participates in providing data that causes a machine to operation in a specific fashion. In an embodiment implemented using computer system 300, various computer-readable storage media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of computer-readable storage media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable storage media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

We claim:

1. A method, comprising:
a content provider continuously measuring and storing the available bandwidth of a plurality of links connecting a plurality of datacenters to a computer network;
a first datacenter receiving a request for data;
based on the stored available bandwidth information, determining which datacenter from the group of datacenters should service the request;
redirecting the request to a second datacenter with a reference from the first datacenter, wherein the reference includes an indicator to the second datacenter to inform the second datacenter that the request is a redirected request.

2. The method of claim 1, further comprising:
servicing the request at the second datacenter.

3. The method of claim 1, wherein the step of measuring the available bandwidth of the plurality of links comprises making bandwidth inquiries to routers and other network devices present within the links.

4. The method of claim 1, further comprising:
servicing the user from a co-located server.

5. The method of claim 4, wherein the measurements comprise bandwidth inquiries that include all links between the co-located server and an IP address of the user originating the request for data.

6. The method of claim 1, wherein the user is located on a network belonging to the content provider.

7. The method of claim 1, wherein the user is located on a network belonging to a partner network of the content provider.

8. The method of claim 1, wherein the user is located on a network belonging to a partner Internet service provider of the content provider.

9. The method of claim 1, further comprising:
the second datacenter reading the indicator; and
affording priority to the request for data.

10. The method of claim 1, wherein the step of continuously measuring and storing is the form of a consolidated list of bandwidth availabilities.

11. The method of claim 10, wherein the consolidated list of bandwidth availabilities is specific to a particular user that is requesting data.

12. A method, comprising:
receiving a request for data from a user belonging to a computer network having a plurality of links;
querying a plurality of routers within the a plurality of links, using the IP address of a user, thereby determining an autonomous system to which that user's IP address belongs;
re-querying the plurality of routers to obtain a next hop within the autonomous system for all network links within the computer network;
identifying links with next hop autonomous system equal to the user's autonomous system; and
calculating the bandwidth available on each of those links having the same next hop autonomous system.

13. The method of claim 12, further comprising:
serving the request using the link that has the most bandwidth available.

14. The method of claim 12, further comprising:
measuring the health of the plurality of links;
serving the request using the link that satisfies a variety of criteria including but not limited to bandwidth availability of a link and also health of a link.

15. A system for accommodating a request for data over a network, comprising:
a routing module for determining which of a plurality of datacenters within the network is capable of servicing the request;
a bandwidth availability service for making bandwidth inquiries to routers and network products within a plurality of links within the network and reporting the findings to the routing module;
wherein the routing module decides which datacenter will service the request.

16. The system of claim 15, further comprising:
the routing module making the decision based at least in part on information provided by the bandwidth availability service.

17. A computer-readable storage medium storing one or more sequences of instructions which, when executed by one or more processors, causes the one or more processors to perform the following steps, comprising:
a content provider continuously measuring and storing the available bandwidth of a plurality of links connecting a plurality of datacenters to a computer network;
a first datacenter receiving a request for data;
based on the stored available bandwidth information, determining which datacenter from the group of datacenters should service the request;
redirecting the request to a second datacenter with a reference from the first datacenter, wherein the reference includes an indicator to the second datacenter to inform the second datacenter that the request is a redirected request.

18. The storage medium of claim 17, further comprising:
servicing the request at the second datacenter.

19. The storage medium of claim 17, wherein the step of measuring the available bandwidth of the plurality of links comprises making bandwidth inquiries to routers and other network devices present within the links.

20. The storage medium of claim 17, further comprising:
servicing the user from a co-located server.

21. The storage medium of claim 20, wherein the measurements comprise bandwidth inquiries that include all links between the co-located server and an IP address of the user originating the request for data.

22. The storage medium of claim 17, further comprising:
the second datacenter reading the indicator; and
affording priority to the request for data.

23. The storage medium of claim 17, wherein the step of continuously measuring and storing is the form of a consolidated list of bandwidth availabilities.

24. The storage medium of claim 23, wherein the consolidated list of bandwidth availabilities is specific to a particular user that is requesting data.

25. A computer-readable storage medium storing one or more sequences of instructions which, when executed by one or more processors, causes the one or more processors to perform the following steps, comprising:
receiving a request for data from a user belonging to a computer network having a plurality of links;
querying a plurality of routers within the a plurality of links, using the IP address of a user, thereby determining an autonomous system to which that user's IP address belongs;
re-querying the plurality of routers to obtain a next hop within the autonomous system for all network links within the computer network;
identifying links with next hop autonomous system equal to the user's autonomous system; and
calculating the bandwidth available on each of those links having the same next hop autonomous system.
